(19) United States
(12) Patent Application Publication
(10) Pub. No.: US 2011/0307930 A1
(43) Pub. Date: Dec. 15, 2011

(54) SYSTEMS AND METHODS FOR TRANSFERRING A PARTIALLY VIEWED VOD PROGRAM FROM A FIRST SERVICE LOCATION TO A SECOND SERVICE LOCATION

(76) Inventors: Alan Rouse, Lawrenceville, GA (US); Charles Dasher, Lawrenceville, GA (US)

(21) Appl. No.: 12/815,002

(22) Filed: Jun. 14, 2010

(51) Int. Cl. H04N 7/173

(52) U.S. Cl. 725/98

(57) ABSTRACT

In one embodiment, a capability is disclosed for a user to pause a VOD program being viewed at a first video service provider (“VSP”), such as a cable service provider. The user then requests to resume viewing of the remaining portion of the VOD program using a separate display device, typically in another location using a different VSP. The streaming of the remaining portion can originate by a connection from the separate display device to the first VSP using a connection through the second VSP. Or, the streaming of the remaining video can occur by the second VSP streaming the remaining portion of the video. In the later case, the bookmark location must be communicated from the first VSP to the second VSP. Other embodiments allow transferring the remaining portion of the video program from the first VSP to the second VSP for streaming.

### FIELD OF INVENTION

This invention, in one embodiment, generally pertains to systems and methods for providing VOD content that is partially viewed at a first location using a first service provider, and the remaining portion is viewed at a second location using a second service provider.

### BACKGROUND OF THE INVENTION

Digital television cable service is commonly available to users desiring to receive television programming. Many cable service providers have converted to providing digital transmission of video data, because using digital data has facilitated the storage, copying, and other video programming functions. For example, video on demand (“VOD”) service readily allows viewers to view programs, such as movies at their convenience, as opposed to adhering to a scheduled broadcast time. VOD service also readily provides functions such as “pause” and “resume.” Some cable service providers have also provided increased flexibility of viewing programming by allowing viewers to 1) watch a portion of a program during a first time period, 2) “bookmark” that location, and then 3) resume watching the remainder of the program at a later time at the same television set. In some instances, the “later time” can be up to 24 hours later. When the viewer resumes, the system uses the “bookmark” location to resume viewing so that the user does not have to fast forward through the first portion to determine the location where they paused viewing. This service facilitates viewers dealing with day-to-day interruptions, which appear to be increasingly common.

Contemporaneously, Internet access service has become largely available to viewers, and in many instances, cable service subscribers regularly use computers to access and view Internet based video content using a computer. Because computers can now easily store and process digital video files, the Internet has quickly grown in its ability to provide users with video clips. Some websites can even provide the same television programming content that is available over the cable television network. Further, Internet access and hence the above identified video programming can be provided using wireless networks, so that mobile users can view video content as well.

In some instances, viewers who interrupt watching a VOD program on a cable system would like to resume viewing using an Internet capable device or at some other location. Thus, there is a need for methods and systems for allowing a viewer to watch a first portion of a VOD program, and then view the remainder portion at a later time at a different location and using a different service provider.

### BRIEF SUMMARY OF THE INVENTION

In one embodiment,

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of the service operation

FIGS. 2a and 2b illustrate embodiments of a network architecture;

FIG. 3 illustrates one embodiment of the VOD Management Server;

FIG. 4 illustrates one embodiment of the server processing flow; and

FIG. 5 illustrates one embodiment of the client processing flow.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including but not limited to hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

The service described herein provides for allowing viewing a first portion of a VOD program at a first location using a first video service provider and subsequently viewing the remaining portion of the same VOD program (typically) at a second location and using a second video service provider. In concept, this can be referred to as “transferring” the remaining portion of the VOD program associated with a first video service provider to a second video service provider. However, use of this terminology does not necessarily mean that the remaining digital video file of the program is actually transmitted to the second service provider. In various embodiments, the remaining portion of the VOD video program itself (e.g., a data file) can be transferred or streamed from the first video service provider to the second video service provider. In other embodiments, the first video service provider may transfer location information, a so-called “bookmark” and program identifier to the second service provider, along with accounting information to allow the second video service provider to stream the program. In this embodiment, the second service provider may already have the indicated program, and hence there is no need to transfer or stream the program itself.

The “first service provider” is typically of a different type than the “second service provider.” This description is not intended to preclude common ownership of the two service providers. In other words, it is possible for a common entity to provide cable access via a first service provider, and also provide wireless service via a second service provider. Although owned by one entity, these would still be considered as two service providers.

Typically, the user views the remaining portion of the VOD program at a different location. For example, a viewer may view a portion of a VOD movie at home, and then view the remaining portion using a wireless smart phone while traveling. Of course, in many cases nothing would prevent the user for using the wireless smart phone at their home where their TV is located, but that is an exception. In most cases, the remaining portion of the movie would be viewed on the wireless phone in a different location.

The individual viewing the first portion using the first video service provider is typically, but not necessarily, a subscriber of both the first video service provider as well as the second video service provider. Typically, the viewer has some authorization to be using each video service provider, even if there is no specific or associated monetary cost associated with doing so.

For purposes of illustration, the service will be described in the context of a cable service provider as the first service provider and a wireless Internet provider (e.g., a cell phone service provider) as the second video service provider. In some instances, for convenience of illustration only, these may also be referred to as a local and remote service provider respectively. However, the principles of the present invention apply to various other types of video service providers and distribution technologies. For example, in one embodiment the second video service provider could be a closed system, such as a hotel cable system. Thus, the scope of the invention is not necessarily limited to the embodiments disclosed. Further, although the embodiment illustrating an embodiment discloses the first service provider is a cable service provider and the second service provider a wireless carrier, in other embodiment the first service provider could be a wireless provider and the second service provider a cable service provider. In other words, it is not necessarily that the initial service provider is a wireline provider and the second service provider is a wireless provider. Those skilled in the art will recognize that there are a number of variations that are possible.

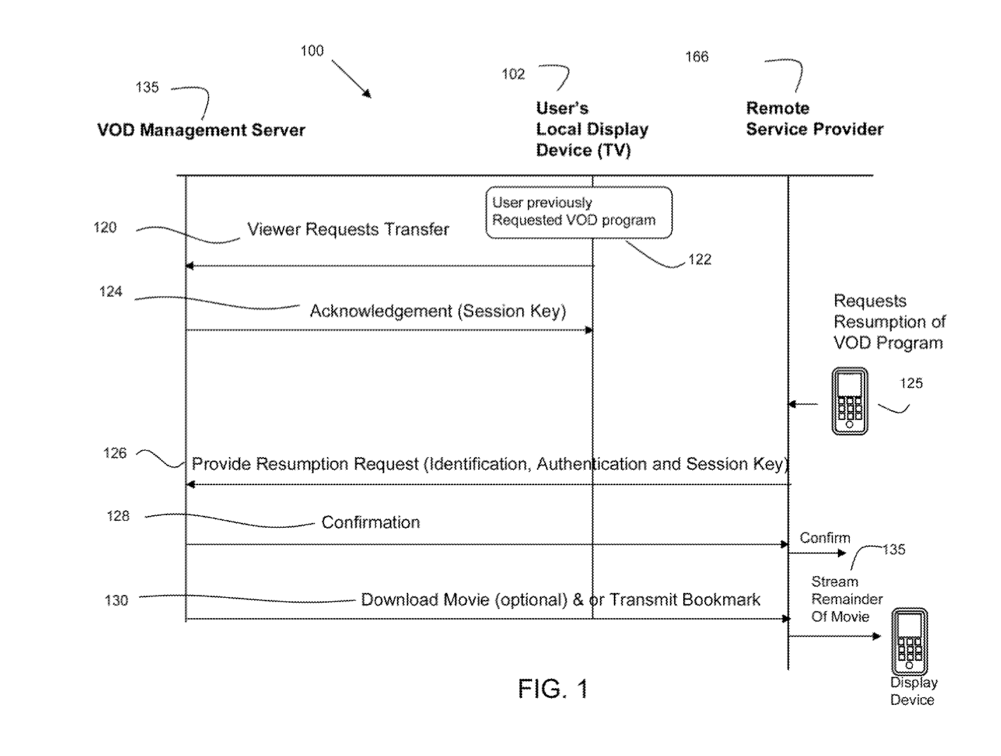

One embodiment of the service overview is shown in FIG. 1. In the overview 100 of FIG. 1, three entities are shown. First, the VOD Management Server 135 is depicted, and for the moment, this can be described a VOD Management Server in the first service provider. The second entity illustrated is the User's Local Display Device 102, which in this embodiment is a television connected to a set top box interfacing with a cable distribution network. Finally, there is a third entity represented by the Remote Service Provider 166, which can be thought of as a wireless service provider interfacing with a wireless device also operated by the viewer.

Typically, the viewer is a user of the service who is a subscriber of the first service provider, and may be a subscriber of the second service provider. In this example, the viewer is a subscriber of both, but this is not necessarily always the case.

The diagram 100 illustrates service requests and responses, where time progress in a downward direction, and the vertical lines associated with the various entities illustrate the originating or terminating entity associated with a request/response. The request/response is shown as horizontal line.

The service presumes that the user has invoked the VOD service 122 and is presently viewing a selected VOD program. The embodiment is illustrated as the user viewing a movie, but it can be appreciated that any type of program can be selected. The procedures for invoking the VOD service can be those existing in the art.

At some point, the user may encounter an interruption, which precludes them from viewing the remainder of the movie. The viewer requests in step 120 to invoke a service allowing them to “pause” the program and “resume” viewing at another location. For sake of simplicity, this will be referred to as invoking a “transfer service.” This request results 111 the cable service provider ceasing streaming the movie. Although not readily apparent to the viewer, the VOD Management Server 135 notes the location in the movie where the transfer request is made. This location is referred to as a “bookmark.” The request can be made in one embodiment by the user activating a function key on the remote control, which sends a signal to the set top box. In one embodiment, the user invokes the “pause” button, and a menu is presented to the viewer prompting the viewer to indicate whether the remaining portion of movie program is intended to be viewed at a later time. In the present embodiment, the viewer is cognizant when they interrupt the movie whether they intend to resume the movie using a different viewing device at a different location.

For example, in one embodiment, a user may be watching a movie prior to initiating travel. Thus, the viewer may have an hour prior to departing on a business trip, and decides to watch the first half of a movie. The viewer knows when pausing the movie that they intend to resume viewing of the movie using their mobile cell phone, for example. This can be indicated using a separate menu to the viewer, pressing a separate function key, etc. In this embodiment, the cable service provider prompts the viewer upon receipt of the “pause” function as to whether the pause function is a “temporary” or “short-term” pause, meaning that the users anticipate resuming the program using the same display device (e.g., the television set), or whether the pause function is a precursor to using a different display device (e.g., a smart cell phone) at a later time. For purpose of illustration, this can be referred to as a “transfer” or “long-term” pause. Typically, the “later time” will be within a defined time period. Typically, this period is set to 24 hours, although this value can vary and is set by the cable service provider. For purposes of illustration, it is assumed that the viewer has paused the program for purposes of invoking the transfer service. That is, the viewer has responded to a menu option or otherwise indicated that they desire to resume viewing using a different device.

In step 124, the network acknowledges the request for the service. In one embodiment, the network provides the viewer with a session key, which comprises information that the VOD Management Server maintains for the defined period and which can be used by the VOD Management Server when resuming viewing of the program. Specifically, this information can be used when the viewer is uncertain as to where, or what equipment, will be used to view the remaining portions of the movie.

The session key is optional, because in some embodiments the cable service provider will have information as to which type of equipment will be used by the viewer to view the remaining portion of the movie and the identity of the second service provider. Specifically, in certain embodiments the viewer can register their remote display device. For purpose of illustration, this is presumed to be a wireless smart phone capable of receiving data. The registration information maintained by the cable service provider (which may be stored or accessed by the VOD Management Server may include the viewer's phone number, device identifier, and service provider). In one embodiment, the cable service provider will know the viewer's account information when the transfer request is made, and will limit the resumption of the movie to only the registered devices.

In other embodiments, the viewer may not necessarily know the second service provider and has not established a registered profile of the remote device being used. Alternatively, the viewer may have registered a device, but chooses not to use it. For example, the viewer may be traveling on business and staying in a hotel. Once checked into the hotel, the viewer may desire to resume viewing of the movie. In this embodiment, the viewer may not necessarily be able to provide information in advance indentifying the service provider or device being used.

For purposes of illustration in FIG. 1, it will be presumed in one embodiment that the viewer has registered in advance as to what device and service provider will be used to resume viewing of the movie. In this embodiment, it will be a wireless phone using a wireless service provider.

After the VOD Management Server acknowledges the request for transferring the movie in step 124, the movie is no longer streamed to the viewer. The VOD Management Server may also provide the user with instructions as to a time limit that the movie can be resumed, and how to accomplished this. At this point, the user can deal with the interruption as necessary. When the user is ready to resume viewing the program, the user then interacts with the remote device as shown in step 125. The user may access a web site (hosted by the VOD Management Server 135) using their mobile device. This web site may be hosted in the wireless service provider, the cable service provider, or a third party. The details of where the web site is hosted does not impact the principles of operation of invention.

In step 126, the remote VOD client 166 initiates a request to the VOD Management Server 135 to resume the movie. The request may include, in various embodiments, explicit identification of the movie (program identification), identification and authentication of the viewer, and the aforementioned session key. It is not necessary to convey this information in each request. In one embodiment, the Remote Service 166 authenticates the mobile device, and provides an identifier in the messaging to the VOD Management Server 135, which then identifies the viewer's account. Once the viewer's account is identified, the VOD Management Server can then identify the previously paused VOD program. The viewer's account includes the registration information which includes the appropriate destination address of the mobile device. Thus, once the VOD Management Server knows that user is requesting resumption of viewing the movie, the VOD Management Server can ascertain the required information to complete the transaction.

In other embodiments, the user may be required to provide one or more of: device identification, user identification, user authentication, and/or session key information. For example, a user may desire resuming viewing of the movie over a laptop computer connected to a hotel's Wi-Fi service. This laptop may not have been previously registered, or may not be listed in the registered profile The user may access the web site and provide account related information (including one or more of the aforementioned parameters), so that the VOD Management Server can ascertain the viewer and the appropriate paused VOD session.

The VOD Management Server must be able to unambiguously identify the paused VOD session, because the VOD Management Server must retrieve the bookmark that was created when the movie was paused. The bookmark can be defined as a time offset from the beginning of the program at which the movie was paused. Typically, a viewer's account will have only one paused VOD session, but it is possible in other embodiments to allow a viewer to have multiple paused VOD sessions. The bookmark location may be used by the VOD Management Server to locate the position in the digital video file, or the bookmark location may be transmitted to the remote service provider. In various embodiments, the cable service provider may transmit the remaining portion of the movie directly to the remote service provider, or if the remote service provider has access to the program locally, may inform the remote service provider of the bookmark which is then used to identify the remaining portion of the program. In one embodiment, the remote service provider can retrieve the remaining portion of the program from a local VOD server having the same content, and stream it locally to the viewer.

In step 128, the VOD Management Server 135 provides confirmation that the paused VOD session can be resumed. The confirmation may include the bookmark location if the remote service provider is streaming the contents of the movie. The confirmation information may also include accounting information to reconcile any reimbursements which are to occur between the cable service provider and the wireless service provider. In many embodiments, the viewer has paid for viewing rights of the program at their cable service provider, and is not explicitly required to pay again to view the remaining portion of the movie.

The confirmation message 128 may further include various other messages between the VOD Management Server and the remote service provider, including the exchange of license information, decryption information, and account/billing information. This exchange of information is typically not directly visible to the viewer, and usually the viewer is only presented with a confirmation that the movie can be resumed.

In step 130, the VOD Management Server 135 downloads (or may control another VOD Server to download) the remaining portion of the movie to the display device. Although this embodiment illustrates the display device as a mobile phone, other embodiments may involve use of a PC, laptop, PDA, tablet, hotel television, or other device.

In various embodiments, the VOD Management Server may allow only a single pausing session for a movie, but in other embodiments additional pausing sessions may be invoked. Thus, after the movie is being streamed to the user in step 135, it is possible that the movie could be subsequently paused and resumed.

### System Architecture

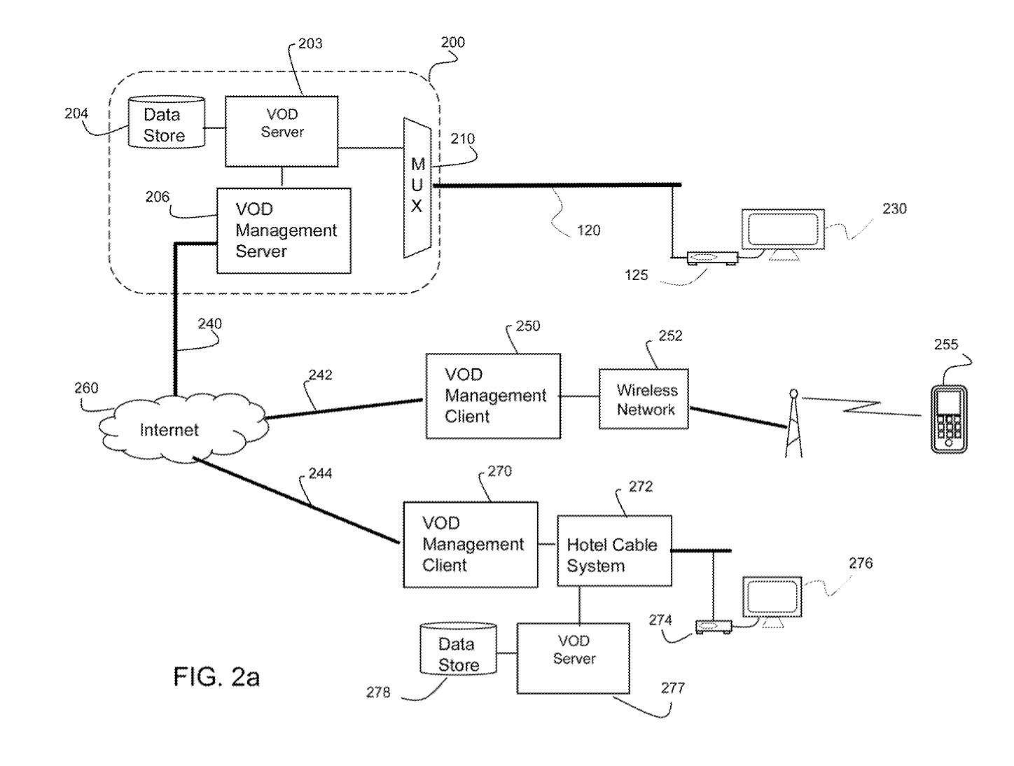

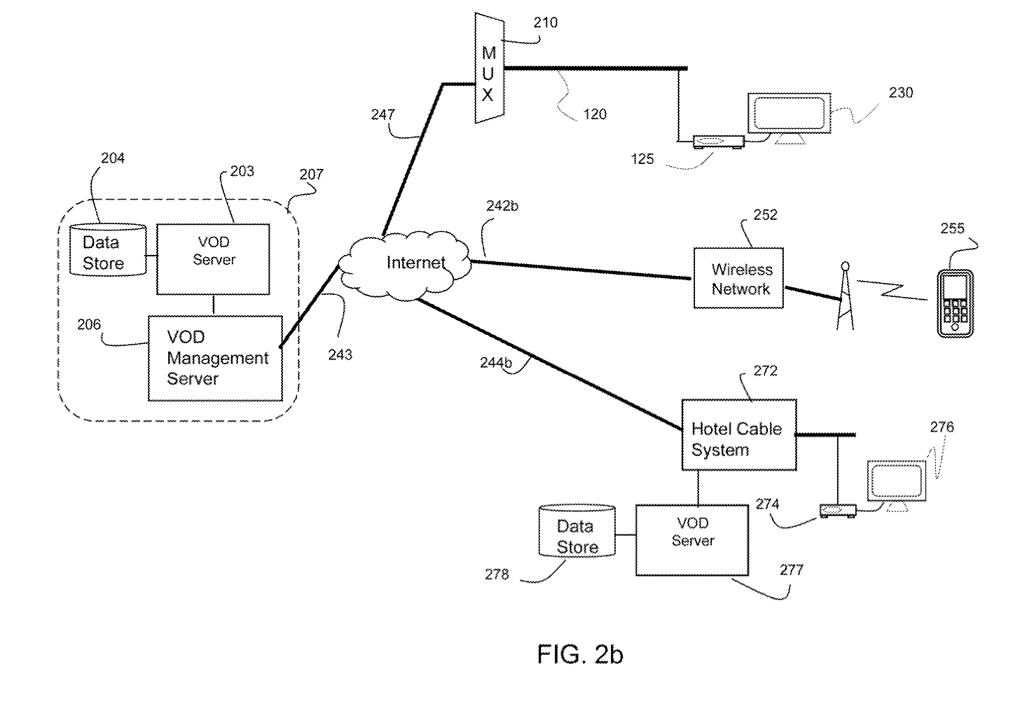

The system architecture for providing the aforementioned service is shown in one embodiment in FIG. 2a. In FIG. 2a, three exemplary display devices and associated networks are illustrated. First, the cable distribution network 120 is illustrated that interfaces with a set top box 125 for receiving and presenting signals to a television 230. The set top box may also incorporate programming logic executing on a processor for providing the service, including presenting a menu of titles available for selection, and interacting with the viewer when the viewer requests pausing a program. The set top box may also provide other functions in conjunction with the viewer requesting the initial VOD program.

The second display device shown is a wireless device 255, such as a cell phone, smart-phone, tablet, or other wirelessly communication device, which could also be a laptop with an appropriate wireless communications interface. This is served by a wireless network 252 which may incorporate a VOD management client 250.

The third type of display device is a television 276, but which is connected to a set top box 274 associated with a hotel cable system 272, which is a “closed” cable system, as it only serves a limited base of devices. This also may incorporate a VOD Management Client 270, but other embodiments may not include the VOD Management Client. In this embodiment, both the VOD management client 270 and 250 are connected via communication facilities 242 and 244 to the Internet 260, which in turn has access to the VOD Management Server 206 via communication facility 240. In this embodiment, the Hotel Cable System 272 has access to a VOD Server 277 and Data Store 278 storing programs. Thus, the hotel can provide VOD programs to its own guests, as is well known in the art.

The cable service provider is shown in this embodiment as having a headend 200 which can broadly be construed as the various equipment use to provide content over the cable distribution network. The headend comprises a multiplexer 210, which receives signals from a VOD server 203. These signals comprises the streamed VOD program that is retrieved from data store 204. In other embodiments, the data can be provided directly from the data store to the multiplexor. The VOD management server 206 interfaces with the VOD Server 203 to 1) provide the necessary control based on requests from the viewer at television 230 to pause the selected movie, and 2) receive requests from the same viewer from one of devices 255, 276 to then resume the movie.

Thus, to summarize, the viewer at television 230 requests a VOD program by interacting with a remote control (not shown). The set top box in one embodiment has an application which presents the VOD menu titles, and allows the user to select a VOD title, and then transmit the request to the VOD server 203. The VOD server informs the set top box of a new channel on which is conveyed the VOD program, and the VOD server streams the requested VOD program over the multiplexer 210, and over the cable facility 120. At some point, the viewer requests to pause the program, and the set top box 125 instructs the VOD server to pause the program. The set top box can be further programmed to prompt the user as to whether the movie will be resumed at the viewer's previously registered mobile device. If the viewer selects “yes”, then the set top box informs the VOD server, which informs the VOD Management Server. In other embodiments, the message from the set top box from the user can be sent directly to the VOD Management Server. In this embodiment, the VOD Management Server handles the processing associated with the transfer service; or in other words, capabilities above and beyond providing the VOD service are handled by the VOD Management Server whereas the VOD Server handles the VOD processing. However, these two modules could be easily integrated into one component.

The VOD Management Server is informed of the location within the program at the moment when the pause request is received, as well as the program identifier, which identifies the program (movie) involved. The VOD Management Server maintains this information as a pending pause transaction in conjunction with an account associated with the viewer. At this point, streaming the VOD program is ceased to the viewer at the set top box 125.

When the user requests to resume the movie, there are two alternatives possible. In the first case, the viewer may have previously registered a particular device associated with resuming the movie. Typically, this will be a mobile device. In this case, the VOD Management Server maintains information associated with the viewer's account necessary to stream the remaining portion of the movie to the viewer. The VOD Management System typically identifies the appropriate viewer's account by information included in the request from the mobile device. That is, information such as an originating telephone number or mobile identification device is used to look up the appropriate account information. This information can be used to both identify and verify the user. Once the originating mobile device is known, the VOD Management System can use the account information to further authenticate the user, and determine which movie was previously requested to be transferred.

In the second case, the user has not previously registered the device from which resumption is requested. This may encompass the situation where the user is using a laptop or other computer (which does not have a fixed IP address, mobile identifier, or originating mobile number) at a remote location (e.g., a hotel room). This could reflect the user desiring to resume watching a movie while on a business trip, and connectivity is obtained through a Wi-Fi connection though the Internet to the cable service provider. In this case, the user may be prompted to provide identification information such as their name, account number, and/or address information. Once a preliminary identification is obtained at the VOD Management Server, the VOD Management Server may prompt the user for additional verification information. In certain embodiments, the VOD Management Server may also request the session key to identify the particular session. However, this is not required in all embodiments.

The VOD Management Client 250, 270 is used in one embodiment where the local service provider, such as the Hotel Cable System 272, streams the remaining portion of the movie to the viewer. In this embodiment, for example, a hotel may have its own library of VOD programs available to guests via a locally connected VOD server 277 that stores programs in data store 278. Thus, when a guest desires to resume watching a previously indicated movie, the remaining portion of the movie is streamed from the hotel's VOD system. The VOD Management Client in this case is used to receive the bookmark information from the cable service provider and process this to determine the location at which to begin streaming. Other interactions may occur between the VOD Management Client and the VOD Management Server to reconcile accounting information. For example, the Hotel may have an agreement to not bill the guest viewer, but instead seek compensation from the cable service provider.

In another embodiment involving the remote service provider streaming the movie, the local service provider may not have that particular stored in the data store and must obtain a copy. Thus, the VOD Management Client may be used to receive the remaining portion from the VOD Management Server 206, temporarily store the movie, and then stream the movie to the guest. The VOD Management Client can interact with the VOD Management Server in various ways in this embodiment. For example, assuming the viewer is requesting resumption of the movie from a hotel cable system, the VOD Management Client 270 can:
a. request the remaining portion of the VOD program from the VOD Management Server;
b. receive a bookmark from the VOD Management Server as to where in an indicated program resumption of playback should occur;
c. receive a license from the VOD Management Server authorizing the temporary storage and decryption of the remaining portion of the program in a local data store of the hotel VOD system; and
d. exchange accounting information to allow billing between the cable service provider and the hotel.

Continuing with the above example, if the hotel does not have the VOD program available in its VOD server system, and the cable service provider does not download the remaining portion of the movie to the hotel, it is possible for the cable service provider to stream the remaining portion of the movie directly to the user's device. This can occur, for example, by streaming the remaining portion of the movie over an Internet connection established between the user and the VOD Management Server 206. In this case, there is direct communication between the viewer's display device and the cable service provider, so that the VOD Management Client functionality is not required in the hotel's system. Essentially, the viewer can receive the remaining portion of the movie over any device capable of accessing the Internet, provided of course, sufficient bandwidth is available. One embodiment reflecting this embodiment is shown in FIG. 2b.

FIG. 2b is similar to FIG. 2a, and the description of the elements in common are not repeated. In this embodiment, the VOD system functions 207 are shown as interfacing via facility 243 to the Internet, which in turn is interfaced via facility 247 to the multiplexor 210. In this configuration, the VOD system 207 commonly serves the cable service provider and the wireless network provider. The wireless network 252 has a similar connection 242b to the Internet to receive streaming movies from the VOD system 207. It is also possible for the hotel cable system 272 to also receive streaming videos over connection 244b. In this case, the locally connected VOD Server 277 and data store 278 is not used by the hotel provider for streaming the remainder of the movie. The service providers may access a common third party VOD service provider to receive VOD programming. In this case, the remaining portion of the video can be streamed from the VOD service provider 207 to the viewer. In this case, it is not necessary to have the VOD Management Client present in the wireless network, so that any user with access to a high speed Internet connection can request viewing of the remaining portion of the movie, without relying on the remote service provider incorporating the VOD Management Client.

### VOD Management Server Architecture

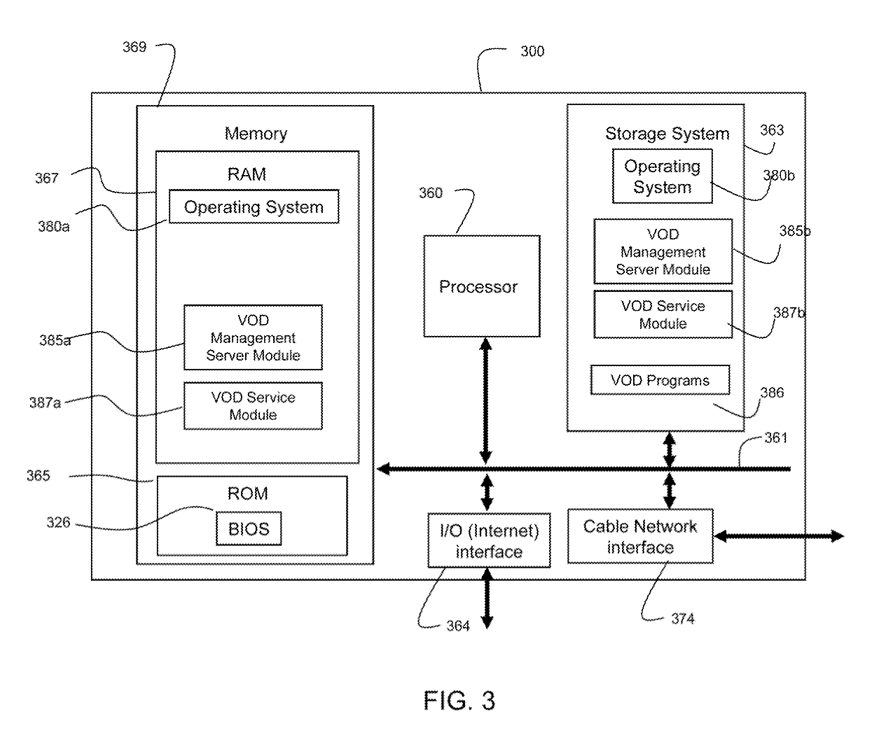

One architecture of the VOD Management Server 206 is shown as system 300 in FIG. 3. In this embodiment, the system 300 includes the functionality of the VOD Server 203 and data store 204. Thus, the entire VOD system 207 can be implemented in an integrated manner in one embodiment.

The system comprises a processor 360 which can be a microprocessor, parallel processing system, or other processing structure well known to those skilled in the art. In this embodiment, the processor functions to execute software instructions which are variously stored in memory, including primary memory 369 and secondary memory 363. The primary memory comprises RAM type memory 367 and ROM type memory 365, although other forms can be used. The RAM memory stores a real time accessible copy of instructions associated with the operation system 380a, the VOD Management Modules 385a, and the VOD Service Module 387a. The ROM typically stores a BIOS or “boot-code” 326. The VOD Management Module executes instructions for managing the pausing and resumption of a video program. The VOD Service Module provides the basic VOD service. Typically, there is some interaction between the two programs. In other embodiments, the processing steps can be designed as a single module, and in other applications, further separate modules can be defined.

The processor 360 accesses the memory using a bus 361, over which data can be transferred. The bus also interconnects to a storage system 363, which can be magnetic disk storage, optical based storage, or various other forms. This secondary storage typically contains a copy of the same software modules, which is loaded into primary memory upon booting the system. In this embodiment, the storage system also includes the VOD programs themselves.

The bus 361 also interconnects the processor with an I/O interface to the Internet, although other interfaces to other networks or devices may be present. Finally, in this embodiment, the system 300 is designed to stream data over a cable network interface module 374, which then provides data to a cable distribution system. Although shown as a single logical system, the components can be implemented using a number of physical components. For example, typically the storage system 363 comprises separate storage modules, which can be geographically dispersed and networked, and the bus 361 can be a high speed network allowing the components to be located in different equipment racks or in different locations. Those skilled in the art will appreciate that many variations are possible with presently available computing systems. Further, in some embodiments, specialized processing equipment can be programmed or otherwise used to provide the necessary capabilities.

### Processing Steps

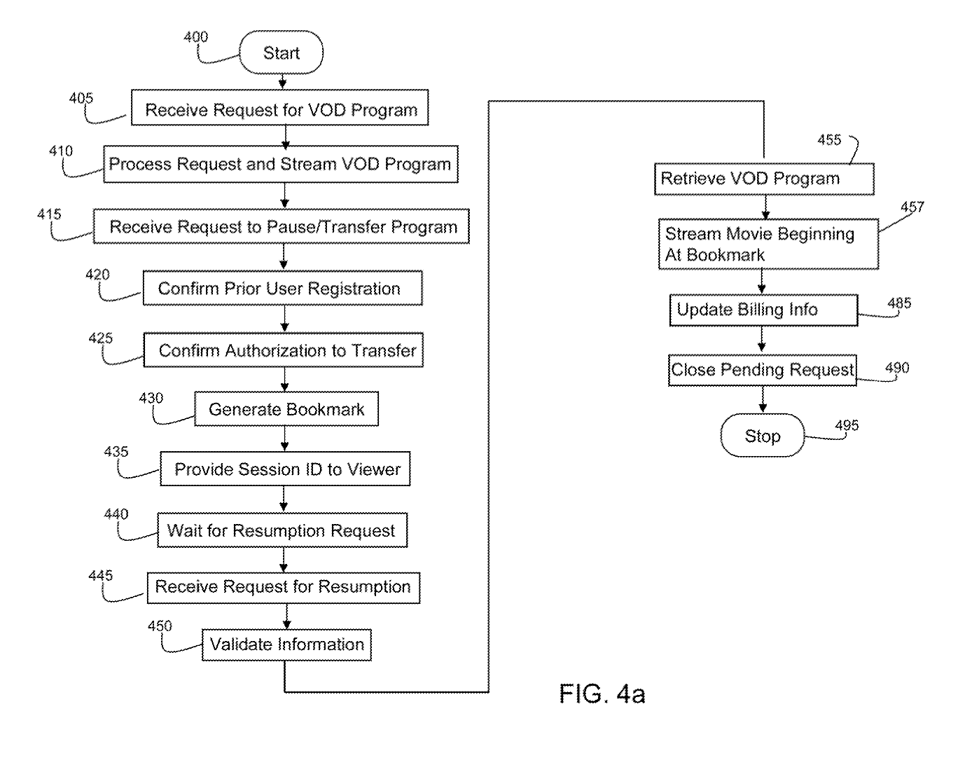

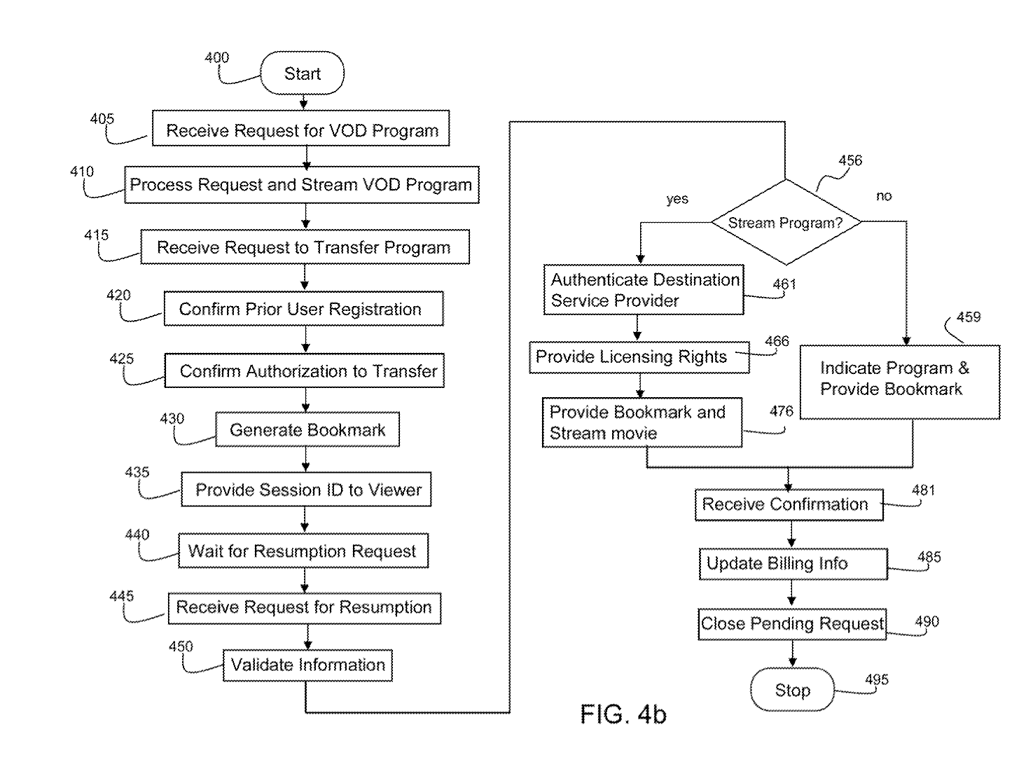

The steps executed in the processing system 300 of FIG. 3 are illustrated in one high level processing flow in FIG. 4. In FIG. 4, the process starts with step 405 receiving a request for the VOD program. In some embodiments, the VOD Server may be distinct from the VOD Management Server but they inter-communicate as necessary. In this embodiment, these two components are assumed to be integrated for ease of illustration, and reference will be made to the “system”, which can encompass various embodiments configuration of the VOD Server and VOD Management Server.

The request for a VOD program in step 405 can occur based on existing procedures known in the art for requesting a VOD program. The system processes the VOD request from the viewer, and streams the VOD program to the viewer.

At step 415, the system receives a request from the viewer on the cable system to pause the program. The viewer is prompted either by the system or the set top box as to whether the “pause” is a temporary pause (a so-called “short term pause”) to be resumed by the viewer on the cable system, or whether the viewer intends to resume viewing using a different type of display device (as so-called “long term” or “transfer” pause). The system will then cease streaming of the movie, and note a timestamp indicating the location where the movie was paused.

If the user indicates a “short term pause”, then resumption can occur as normally occurs in VOD. It is assumed that the user has indicated a “long term pause,” i.e., the user intends to resume viewing the movie using a different type of distribution network. In this case, it is further assumed that the user has previously registered a cell phone with display capabilities, and has provided appropriate information required to stream the movie upon receiving a request to resume the movie.

In step 420, the system confirms that the required prior registration information is stored in conjunction with that user's account. Thus, a user that has not previously registered an appropriate device may be rejected at this point (this step is not shown in FIG. 4). In some embodiments, the VOD Management Server may require registration of a remote device, whereas in other embodiments this may not be required. The VOD Management Server is aware of which viewer has made the request to transfer the program in step 415, since the VOD Management Server typically receives a set top box identifier in the request, and uses that information to ascertain the viewer's account.

The system in step 425 may confirm to the user that they have requested a “transfer” pause. This may include, for example, acknowledging to the viewer that the indicated movie can be resumed with 24 hours using the viewer's cell phone and providing instructions as to how the request is to be made.

At this point, in step 430, the system records the previously noted timestamp (or “bookmark”) indicating where the program was paused, along with an identifier of the movie program, and a viewer identifier. This information is stored in memory, and retained for future reference when the viewer requests resumption of the program. The system typically retains this information for a defined time period. In one embodiment, the pending nature of the transaction can be retained by the system for 24 hours, one week, one month, or some other time period. Typically, if the user has not requested resuming the movie within a reasonable time period, then it is likely the viewer has forgotten about the request. Hence, the system will typically erase the bookmark information after the retention period.

In one embodiment, the system may provide to the viewer in step 435 a session identifier. However, this step is optional, and typically is not provided in the case of where the viewer has pre-registered a particular display device to resume viewing of the movie. In this case, identifying the display device is sufficient to identify the viewer, and thus retrieve the data regarding the program and the bookmark.

In the next step 440, the system waits for receiving a resumption request. For sake of illustration, the viewer is assumed to have turned off their TV, and departed on a business trip. At some point within the defined time period, the viewer will request resumption of the movie. Thus, the steps up until this point have likely occurred in a relatively limited time period (most likely no more than two hours, which is the typical length of a VOD movie), but the next step 445 may occur somewhat later in time.

At step 445, the system receives a request for resumption. This request can be received by the VOD Management Server in a number of ways. Since in this embodiment, the user has preregister a mobile display device (e.g., cell phone with a display), it presumed that the user has used the registered mobile display device to make the resumption request. If so, the request could be received via a SMS (short message service) originating from the viewer's mobile display device, or could be received by the viewer accessing a web site hosted by the VOD Management Server. The request to resume includes some sort of identifier allowing the VOD Management Server to identify the viewer in some manner. If the request is from the viewer accessing the web site, the web site could prompt the user for such information (e.g., name, account number, customer number, etc.). If the request includes a mobile station identifier or account name, then this information can be used to determine the viewer's account. The system may ask the user to verify that the proper account has been selected by the VOD Management Server by prompting the user to enter verifying information (e.g., billing address, mobile phone number, etc.).

In step 450, the VOD Management Server validates that the identification information can be used to identify the viewer's account, and verifies that the viewer's service profile indicated in the account allows remote resumption of VOD programs. The transfer service may be a subscription option, and not all cable system subscribers may be authorized to invoke the service. The VOD Management Server also determines if the user has previously paused a VOD program. Obviously, if there was no VOD program that was “paused,” then there can be no VOD program that could be “resumed.” Assuming there is a program that was paused, and it is associated with the viewer's account, then in step 455 the system retrieves the appropriate VOD program and uses the bookmark indicated therewith to begin streaming the movie at the appropriate location in step 457.

In steps 485 the system may update certain billing information associated with providing the remainder of the program. For example, the user may have selected a VOD program while at home served by the cable service provider, and have only watched 10 minutes of the movie. The cable service provider may not bill the viewer for watching the movie because so little was actually viewed. The cable service provider may have an algorithm that requires at least 50% of the movie to be watched before the viewer is billed. Thus, once the viewer has resumed viewing of the movie, there may be various billing algorithms which require updating to reflect that the user has viewed the movie. In step 490, the pending request for resuming the movie can be considered to be closed out.

FIG. 4b indicates a variation of the processing that can occur in the VOD Management Server. In this embodiment, steps 405-450 are the same, so these steps are not discussed again. In step 456, divergence from FIG. 4a is shown. In this step, the VOD Management Server must determine whether it is to stream the program (or otherwise transfer the video file) to the remote server provider. This reflects the embodiment where 1) the remote service provider does not have the movie and desires to receive the movie from the cable service provider and control the streaming to the viewer, or 2) the remote service provider has the movie, but needs to know where to begin streaming the movie to the viewer. Typically, this is reflected by the VOD Management Server receiving a request for either the movie and bookmark, or just the bookmark.

In case #1, the remote service provider (more specifically, the VOD Management Client) is required to be authenticated by the cable service provider in step 461 before the cable service provider will stream the program. Further, there may be a requirement for the cable service provider to also provide a digital certificate, license, or other data authorizing the remote service provider in step 466 prior to stream the movie, and allow the remote service provider to decrypt the movie data. Once this is provided, along with the bookmark, then the movie can be streamed to the remote service provider. These functions are carried out by the VOD Management Client (at the remove service provider) interacting with the VOD Management Server (at the cable service provider).

In case #2, where the remote service provider already a VOD library, there is no need to transfer the movie, nor any need to provide licensing rights, as the remote network is presumed to already have such rights. In this case, there is only need to convey the movie program identifier and the bookmark. This is reflected in step 459 by conveying to the remote service provider the program identifier and the bookmark. Again, this function is carried out by the VOD Management Client interacting with the VOD Management Server. In this case, there may be less functionality required in the VOD Management Client compared to case #1.

Once the appropriate indication is conveyed, then in step 481 the remote service provider may confirm to the VOD Management Server that the resumption of the video can/is being carried out. This allows the cable service provider in step 485 to properly update billing information. In this case, because the remote service provider is streaming a portion of the movie to the viewer, there may be a compensation arrangement between the cable service provider and the remote service provider. Thus, the “billing information” in step 485 that is updated may include updating accounting, information not only by the cable service provider in relation to the viewer, but may also involve updating accounting information in relation to the remote viewer.

### VOD Management Client Process Flow

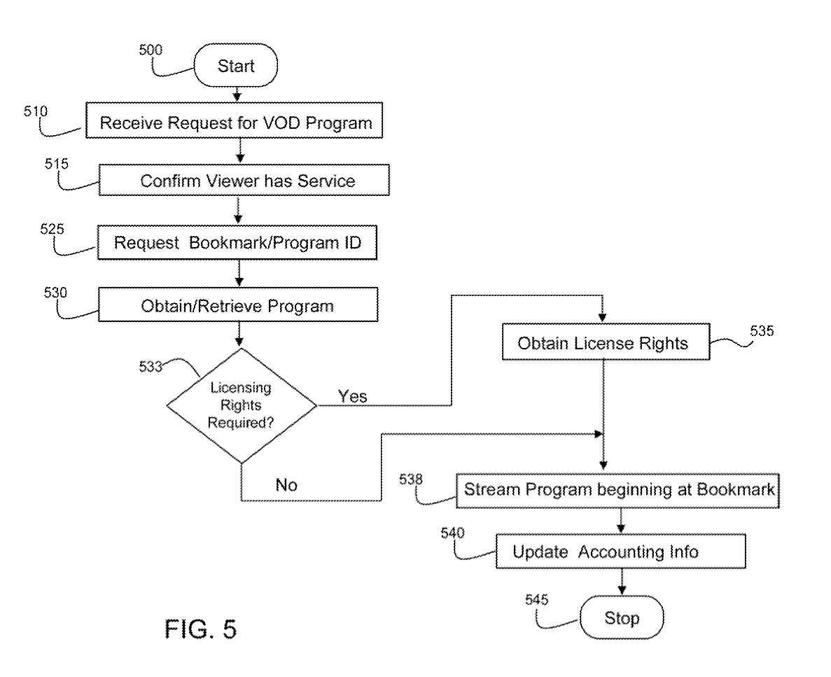

FIG. 5 illustrates one embodiment of the processing flow that may occur on the VOD Management Client system. This client system can have a similar architecture as shown in FIG. 3 in that it has a processor that is programmed to execute steps, but that the steps are shown in FIG. 5.

One application for the VOD Management client is to handle the coordination functions when the remote service provider is providing the remaining portion of the movie. Thus, the remote service provider may have its own VOD server with the same program title that the user is requesting to resume. In this case, the VOD Management Client system (“Client”) receives the request in step 510 for resuming the VOD program. This request typically provides information allowing the Client to ascertain which cable service provider should be consulted for determining which program is to be resumed and what is the appropriate bookmark. Once this is determined, in step 515 the Client confirms with the VOD Management Server that the viewer is authorized for the service, and has a paused VOD program. The Client may request in step 525 the program identifier and the bookmark from the VOD Management Server. This informs the Client as to what program the viewer paused (and wishes to resume) and where resumption in the program resumption should occur.

In step 530 the Client either retrieves the program if stored locally, or may obtain the remaining portion of the program (or its entirety) from the Cable Service Provider. If the movie is stored locally, then in step 533 the Client presumably has the licensing rights and does not need to obtain the rights. If the remaining portion of the program is to be downloaded, then the Client in step 533 may require the licensing rights as shown in step 535. Obtaining the licensing rights may involve asking the VOD Management Server to provide the rights, or may involve obtaining them from a third party licensing broker. Once obtained, then in step 538, the Client can then stream the remaining portion of the movie to the viewer. In step 540, the appropriate accounting information may be updated. This may involve the Client updating accounting information between the remote service provider with respect to the viewer, and/or updating accounting between the remote service provider and the cable service provider.

### Additional Processing Aspects

There may be additional processing associated with providing resumption to a VOD program. The cable service provider may provide programming in standard definition or high definition to the user. However, when the viewer resumes the program using a remote display device, such as when using a tablet or wireless based cell phone, the resolution may be less. Specifically, the bandwidth available for the data transfer to the mobile device may be less than the available bandwidth over the cable system. Thus, a corresponding drop in the encoding rate as used by the cable service provider may be required.

In one embodiment, the viewer indicates parameters that are used by the VOD Management Server to select or determine an encoding rate or encoding format used when streaming the remaining portion of the movie to the viewer's registered display device. For example, the cell phone may require an MPEG-4, H.264, or some other encoding format as opposed to an MPEG-2 based format as used by the cable service provider. The VOD Management Server may note the appropriate encoding format to use based on prior registration of the mobile display device by the user. When the user then requests to resume viewing of the movie and the VOD Management Server streams the video to the remote viewer, the VOD Management Server may transcode the video stream according to information stored in the viewer's account. Alternatively, the VOD Management Server may provide the remote service provider with the encoding standard to use, and request the remote service provider to transcode the mobile video when streaming the remaining portion of the movie.

In other embodiments, the viewer may be allowed to repeatedly pause and resume a video. For example, a viewer may view a portion of a VOD program at their home, and then view a portion of the remainder on a cell phone traveling to an airport, and then finally view the remaining portion at a hotel room. Thus, it is possible to cascade multiple pause/resume requests. In this case, a mechanism is defined allowing the user to indicate a second “pause” function, at which time the VOD Management Server will update its bookmark location.

For example, assume the configuration where the VOD Management Server streams the remaining portion to the user over an Internet connection (thus, no VOD Management Client is involved at the remote service provider). After pausing a program in their home, the VOD Management Server notes the subscriber identifier, the program identifier, and location bookmark. When the user then accesses a web site hosted by the VOD Management Server using a mobile device, the VOD Management Server can identify the subscriber, and the corresponding program and location bookmark. The VOD Management Server can then stream the video to the user. At some point, the viewer can indicate the “pause” function again. The VOD Management Server than notes the location and updates the bookmark to reflect the updated location. At some later point, the viewer can again access the VOD Management Server to request resumption of the remaining portion of the movie. This can be done using the mobile device, or alternatively using a laptop in their hotel room. In this case, the VOD Management Server would resume using the second bookmark and stream the remaining portion of the movie.

It is possible that a user may have registered different devices for transferring the remaining portions of the movie. In the above example, the user may have registered both a mobile device and a laptop. One motivation for doing so is that the wireless bandwidth, display screen size, and other factors may necessitate a lower encoding standard, whereas a laptop (which may typically be used with a wireline connection) that has a larger display may allow a high encoding standard. Thus, the user may desire the flexibility to select which device should be used to retrieve the unviewed portion based on circumstances.

As noted before, the VOD Management Client may be present if the remote service provider does not have a locally stored copy of the movie to stream to the viewer. In this case, the VOD Management Client may interact with the VOD Management Server to request a portion of the program. This requires that the two servers exchange request/response messages as to the identity of the viewer and the corresponding program identifier previously paused, and requesting transfer of the video program to the remote service provider. The transfer of the program can entail transferring the file via FTP and subsequently streaming the file by the remote service provider, or streaming the file to the remote service provider, buffering it, and streaming it to the viewer.

1. A system for providing a VOD program to a viewer wherein said viewer is a subscriber of a cable service provider comprising:
a memory, wherein said memory stores said VOD program, an identifier associated with a mobile device and a viewer identifier;
a processor configured to:
receive a request for said VOD program from a set top box connected to a cable distribution system, wherein said set top box transmits said request based on input from said viewer;
providing a channel identifier of a channel to said set top box;
streaming a first portion of said VOD program over said channel on said cable distribution system;
receiving a second request from said set top box, said request indicating to pause said VOD program;
ceasing streaming of said first portion of said VOD program to said viewer over said cable distribution system;
determining a bookmark associated with said VOD program, wherein said bookmark identifies a location of said VOD program associated with when said streaming of said first portion was ceased;
storing said bookmark and a program identifier identifying said VOD program in memory, wherein at least one of said bookmark or said program identifier is associated with said viewer identifier stored in said memory
receiving a resumption request from said viewer using said mobile device, wherein said resumption request is initiated by said viewer using a communications network that is not said cable distribution system;
using said identifier to retrieve said bookmark and said program identifier;
retrieving a second portion of said VOD program from said memory; and
providing said second portion of said VOD program over said communication network that is not said cable distribution system, wherein said second portion of said VOD program does not include said first portion of said VOD program.

2. The system of claim 1 wherein said resumption request includes said identifier.

3. The system of claim 2 wherein said identifier is unique to said mobile device.

4. The system of claim 3 wherein said identifier is a mobile device identifier.

5. The system of claim 2 wherein said bookmark indicates a time offset and said processor is configured to retrieve said second portion of said VOD program from said memory wherein a beginning of said second portion of said VOD program is indicated by said time offset.

6. The system of claim 1 where said processor is further configured to receive an indication from said set top box indicating that the viewer intends to subsequently resume said VOD program using said mobile device.

7. The system of claim 1 wherein said processor is further configured to ascertain whether a service profile of said viewer authorizes streaming of said second portion of said VOD program to said viewer over said communication network that is not said cable distribution system.

8. The system of claim 1 wherein said processor is configured to;
receive a second pause request from said mobile device; and
cease streaming of said second portion of said VOD program over said communication network.

9. The system of claim 1 wherein said processor is configured to further provide decryption data to prior to providing said second portion of said VOD program over said communication network.

10. A system for providing a VOD program to a viewer wherein said viewer is a subscriber of a cable service provider comprising:
a memory, wherein said memory stores said VOD program, an identifier associated with a mobile device and a viewer identifier;
a processor configured to:
receive a request for said VOD program from a set top box connected to a cable distribution system, wherein said set top box transmits said request based on input from said viewer;
providing a channel identifier of a channel to said set top box;
streaming a first portion of said VOD program over said channel on said cable distribution system;
receiving a second request from said set top box, said request indicating to pause said VOD program;
ceasing streaming of said first portion of said VOD program to said viewer over said cable distribution system;
determining a bookmark associated with said VOD program, wherein said bookmark identifies a location of said VOD program associated with when said streaming of said first portion was ceased;
storing said bookmark and a program identifier identifying said VOD program in memory, wherein at least one of said bookmark or said program identifier is associated with said viewer identifier stored in said memory;
receiving a resumption request from said viewer using said mobile device, wherein said resumption request is initiated over a communications network that is not said cable distribution system;
using said viewer identifier to retrieve said bookmark and said program identifier from said memory; and
transmitting said bookmark and said program identifier to a wireless service provider serving said mobile device wherein said wireless service provider streams a second portion of a second VOD program to said mobile device, wherein the content of said second VOD program is the same as said VOD program, and a beginning of said second portion of said second VOD program is identified by said bookmark.

11. The system of claim 10 wherein said processor is configured to retrieve account information for said viewer using said viewer identifier, wherein said account information comprises an indication said viewer is entitled to request resumption of said VOD program using said mobile device.

12. A method for providing a VOD program to a viewer wherein said viewer is a subscriber of a cable service provider comprising:
storing said VOD program, an identifier associated with a mobile device and a viewer identifier in memory;
receiving a request for said VOD program at a processor from a set top box connected to a cable distribution system, wherein said set top box transmits said request based on input from said viewer;
providing a channel identifier for a channel to said set top box over said cable distribution network;
streaming a first portion of said VOD program over said channel on said cable distribution system;
receiving a second request from said set top box, said request indicating to pause said VOD program;
ceasing streaming of said first portion of said VOD program to said viewer over said cable distribution system;
determining a bookmark associated with said VOD program, wherein said bookmark identifies a location of said VOD program associated with receiving said second request indicating to pause said VOD program;
storing said bookmark and a program identifier identifying said VOD program in memory, wherein both are associated with said viewer identifier in said memory;
receiving a resumption request at said processor from said viewer using said mobile device, wherein said resumption request is initiated over a communications network that is not said cable distribution system;
using said viewer identifier to retrieve said bookmark and said program identifier;
retrieving a second portion of said VOD program from said memory; and
providing said second portion of said VOD program over said communication network that is not said cable distribution system, wherein said second portion of said VOD program does not include said first portion of said VOD program.

13. The method of claim 12 wherein said resumption request includes said identifier and said processor uses said identifier to retrieve said program identifier and said bookmark.

14. The method of claim 13 wherein said processor determines that said viewer is authorized to request resumption of said VOD program.

15. The method of claim 14 wherein said processor uses said bookmark to identify a beginning portion of said second portion of said VOD program.

16. The method of claim 15 wherein said processor streams said second portion of said VOD program.

17. The method of claim 16 wherein said processor receives a second pause request from said mobile device and in response ceases streaming of said second portion of said VOD program.

18. The method of claim 16 further comprising the step of:
providing decryption data prior to streaming said second portion of said VOD program.

19. A method of claim for providing a VOD program to a viewer comprising:
storing said VOD program, an identifier associated with a mobile device and a viewer identifier in memory
receiving a request for said VOD program from a set top box connected to a cable distribution system, wherein said set top box transmits said request based on input from said viewer;
providing a channel identifier of a channel to said set top box;
streaming a first portion of said VOD program over said channel on said cable distribution system;
receiving a second request from said set top box, said request indicating said program should be paused;
ceasing streaming of said first portion of said VOD program to said viewer over said cable distribution system;
determining a bookmark associated with said VOD program, wherein said bookmark identifies a location of said VOD program associated when said streaming of said first portion was ceased;
storing said bookmark and a program identifier identifying said VOD program indexed by said viewer identifier in said memory;
receiving a resumption request from said viewer using said mobile device, wherein said resumption request is initiated over a communications network that is not said cable distribution system;
using said viewer identifier to retrieve said bookmark and said program identifier; and
transmitting said bookmark and said program identifier to a wireless service provider serving said mobile device wherein said wireless service provider streams a second portion of a second VOD program to said mobile device, wherein the content of said second VOD program is the same as said VOD program, and a beginning of said second portion of said second VOD program is identified by said bookmark.

20. The method of claim 19 wherein receiving a resumption request from said viewer using said mobile device comprises said identifier; and
said identifier is used to retrieve account information associated with said viewer.
